(19) United States
(12) Patent Application Publication
(10) Pub. No.: US 2005/0046788 A1
(43) Pub. Date: Mar. 3, 2005

(54) Nose pads to be loosely fixed to front of eyeglasses frame

(76) Inventor: Kunikado Ryushima, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/782,992

(22) Filed: Feb. 23, 2004

(30) Foreign Application Priority Data
Aug. 27, 2003 (JP) 2003-208979

(51) Int. Cl. G02C 5/12

(52) U.S. Cl. 351/136

(57) ABSTRACT

To provide a pair of nose pads which can stay on the nose in the normal position steadily and painlessly, each nose pad is relatively thick and concave or curved inward, and the nose pad has its lower end curved backward. The lower nose-fitting area is smooth-curved.

### BACKGROUND OF THE INVENTION

1. Field of the Invention

The present invention relates to a pair of nose pads to be loosely fixed to the front of an eyeglasses' frame for supporting the front on the nose.

2. Related Art

Referring to FIG. 4, the frame of a pair of eyeglasses comprises a front “a”, and a pair of temples “b” hinged to the opposite sides of the front “a”, permitting them to fold flat on the front “a”. Each rim “c” of the front “a” has a lens fitted therein. The front “a” has two nose pads “d” loosely fixed to the confronting sides of the opposite rims “c”. When the eyeglasses are worn on the face, the nose pads “d” are applied lightly to the opposite sides of the nose, being allowed to automatically adjust their inclination so as to fit on the nose sides, thus supporting the frame front “a” on the nose.

Referring to FIG. 5, the nose pad is an elliptical object of resin material, and its nose application surface is smooth-curved so that it may give a pleasing touch to the nose. It is made of a soft material such as silicone, thereby assuring that a person with eyeglasses does not feel any discomfort on the nose.

The nose pad has a fastening projection “f” formed on its rear side. The nose pad is loosely fixed by screwing the projection “f” to the end block of the leg extension from each rim. It is loosely fastened, and therefore, it may automatically adjust its inclination relative to the nose side until it snugly stays thereon.

FIG. 6 shows how the nose pad “d” can be put snugly on either side of the nose “g”. As seen from the drawing, its application surface “e” cannot be wholly applied to the nose side, and only its lower end “h” is permitted to be in contact with the nose side. The nose is like an equilateral triangle, diverging downwards. Assuming that the front “a” descends on the nose, the nose pad on either side of the nose “g” gradually changes in direction, accordingly increasing its contact area. When the front “a” is raised to the normal position, the contact area decreases. As for the contact-to-contact distance between the opposite nose pads “d”: it increases as the front descends from the normal position, and it decreases as the front rises toward the normal position.

Assuming that the nose pad “d” were kept at the same angle relative to the nose side at the raised or normal position as at the lowered or descendent position, the nose pad “d” would be nowhere in contact with the nose side, causing the front to descend from the normal position again. In order to keep the nose pad “d” on either side of the nose at normal position, the nose pad “d” would have to change in direction so that it may be caught by the nose side.

Specifically, the nose pad “d” rotates clockwise (FIG. 6) and the counter nose pad rotates counter clockwise. As the distance between the opposite nose pads “d” is reduced, they come close toward each other, thus holding the front at the upper normal position, not allowing it to slide down on the nose. In this position, however, the conventional nose pad stands on the lower corner “h”, causing the person to feel some minor discomfort on the nose. Also disadvantageously, the contact area provided by the lower corner “h” on which the nose pad “d” stands is so small that the front is easy to slide on the nose toward the lowered position.

One object of the present invention is to provide an improved nose pad which can stay on the nose in the normal position with its contact area large enough to assure the steady and painless stay of the front on the nose.

### SUMMARY OF THE INVENTION

To attain this object a pair of nose pads to be loosely fixed to the front of an eyeglasses' frame for supporting the front on the nose is improved according to the present invention in that each nose pad has its lower end curved backward, the lower nose-fitting area being smooth-curved.

Also, a pair of nose pads to be loosely fixed to the front of an eyeglasses' frame for supporting the front on the nose is improved according to the present invention in that each nose pad is relatively thick and concave or curved inward, and that the nose pad has its lower end curved backward, the lower nose-fitting area being smooth-curved

The nose pad is larger and heavier than the conventional one in order to assure that the front may be steadily supported on the nose. The nose pad has its lower end curved backward, and its lower nose-fitting area smooth-curved. In case that the front is pushed up from the lower position toward the normal position, the nose pad stand on its relatively large contact area of backward curvature, staying on the nose. Thus, it is assured that the stable and pain-less stay of the front on the nose in the normal position

Other objects and advantages of the present invention will be understood from the following description of a pair of nose pads according to the present invention.

### BRIEF DESCRIPTION OF THE DRAWING

FIG. 1 is a front view of a pair of eyeglasses having nose pads loosely attached to its front, illustrating the eyeglasses in the state of being worn on the face;

FIGS. 2(a), 2(b) and 2(c) illustrate the nose pad in rear, front and side views respectively;

FIG. 3 illustrates how the nose pad varies its inclination with the level on the nose;

FIG. 4 is a perspective view of a conventional pair of eyeglasses;

FIGS. 5(a) and 5(b) illustrate a conventional nose pad in rear and side views; and

FIG. 6 illustrates how the conventional nose pad varies its inclination with the level on the nose.

### DETAILED DESCRIPTION OF PREFERRED EMBODIMENT

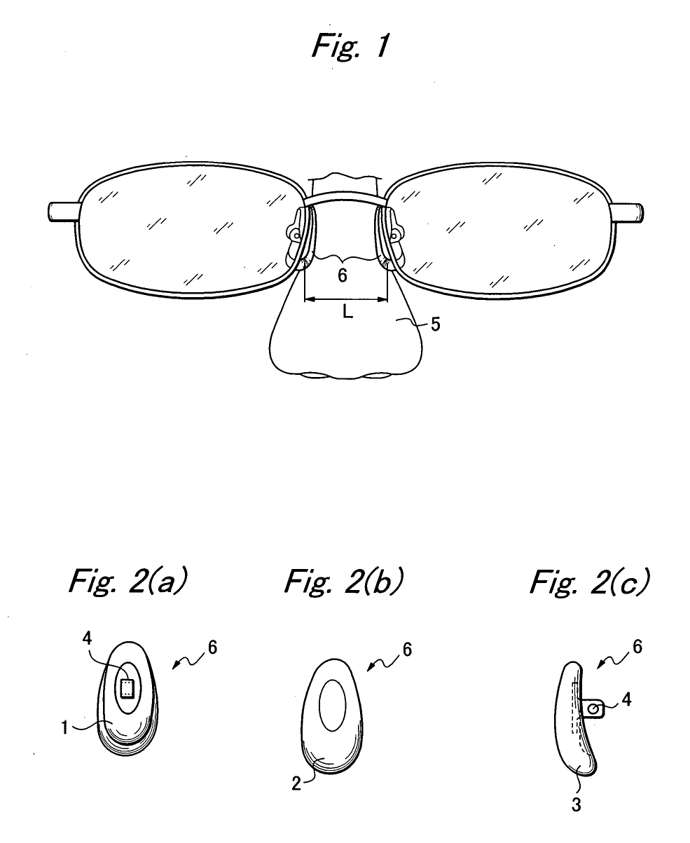

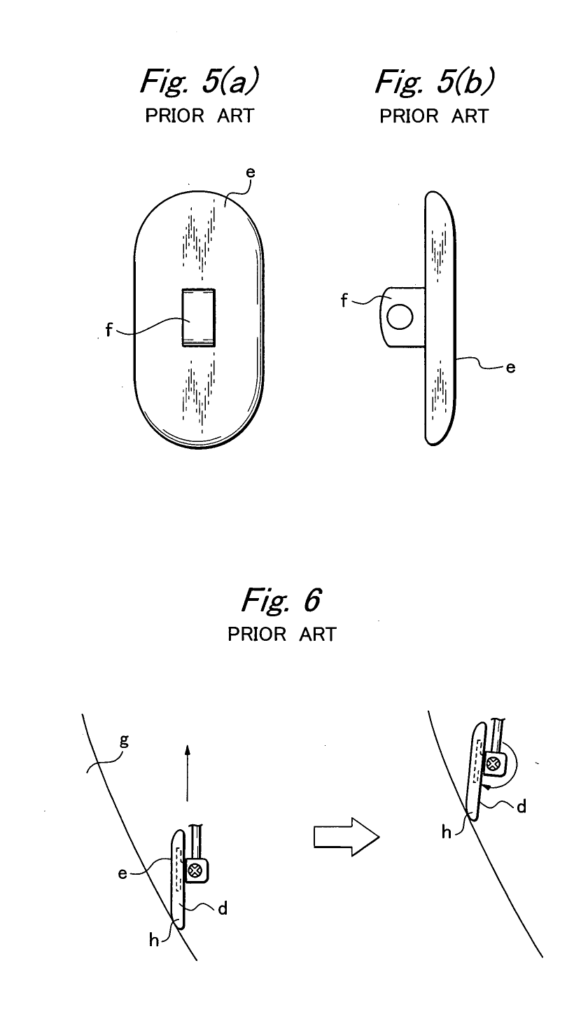

Referring to FIGS. 1 and 2, each nose pad 6 is thick, compared with the conventional nose pad as shown in FIG. 5, and is concave or curved inward on its rear side 1. The nose pad has its lower end 3 curved backward. The lower nose-fitting area 2 is smooth-curved. The nose pad has a fastening projection 4 formed on its rear side, and the nose pad can be loosely fixed by screwing the projection 4 to the end square-block of the leg extension from each rim, as in the conventional nose pad.

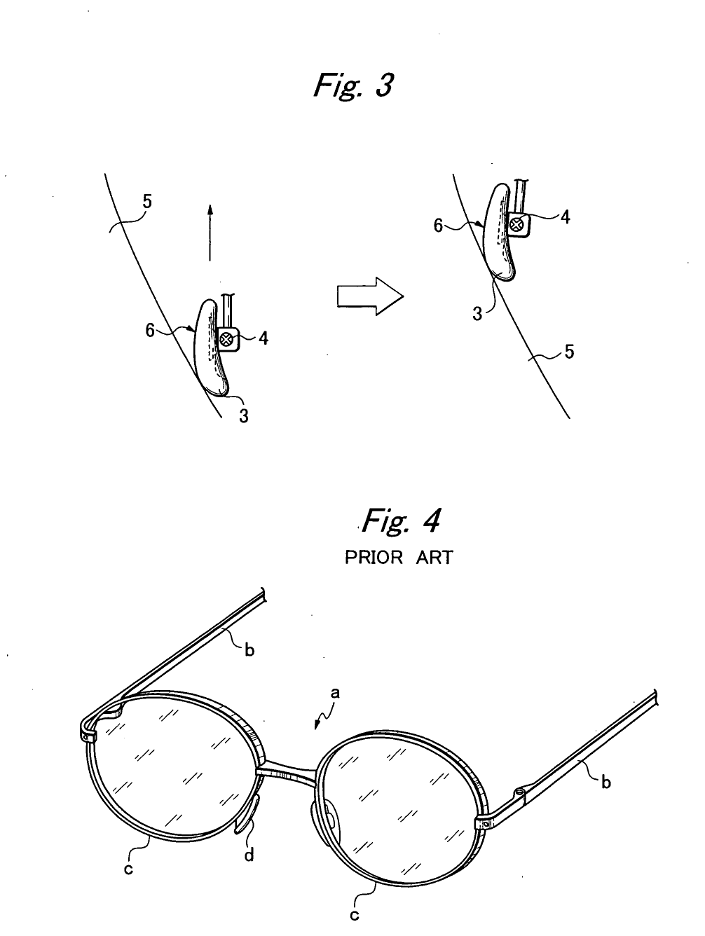

FIG. 3 is similar to FIG. 6, illustrating how the nose pad 6 behaves on the equilateral triangular nose 5 at the normal and descendent positions respectively. At the lower level at which the front comes down from the normal position, the contact-to-contact distance “L” increases so that the right nose pad 6 rotates somewhat about its pivot 4 counterclockwise (or the left nose pad clockwise), and the so leaning nose pad 6 has its contact area increasing more or less on the nose.

When the front is raised toward the normal position, the contact-to-contact distance “L” decreases so that the right nose pad 6 somewhat rotates about its pivot 4 clockwise (or the left nose pad counterclockwise), and the less-leaning nose pad 6 displaces its contact area toward the lower end 3, which is curved backward. The lower nose-fitting area is smooth-curved, and the backward curving so effectively expands the nose-contact area that no discomfort may be caused by the nose pad.

The nose pad according to the present invention has its lower end curved backward, thereby providing the following advantages:
no matter where the front may be on the nose, the contact area remains relatively large enough to cause no discomfort or pain from the eyeglasses on the face; and
the front is resistive to descending from the normal position on the nose.

Also, the nose pad is relatively thick and concave or curved inward, which provides the following advantages:
the front can stay stable on the nose, and
the weight of the nose pad gives a pleasing fit of the frame to the nose.

1. A pair of nose pads to be loosely fixed to a front of an eyeglasses' frame for supporting the front on the nose, wherein each nose pad has its lower end curved backward, the lower nose-fitting area being smooth-curved.

2. A pair of nose pads to be loosely fixed to the front of an eyeglasses' frame for supporting the front on the nose, wherein each nose pad is relatively thick and concave or curved inward, and that the nose pad has its lower end curved backward, the lower nose-fitting area being smooth-curved.
